(19) United States
(12) Patent Application Publication
(10) Pub. No.: US 2012/0131315 A1
(43) Pub. Date: May 24, 2012

(54) DATA PROCESSING APPARATUS

(75) Inventors: Yoshinobu Tanaka, Tokyo (JP); Takashi Yanada, Tokyo (JP)

(73) Assignee: OLYMPUS CORPORATION, Tokyo (JP)

(21) Appl. No.: 13/289,478

(22) Filed: Nov. 4, 2011

(30) Foreign Application Priority Data
Nov. 18, 2010 (JP) 2010-257842

(51) Int. Cl. G06F 9/30

(52) U.S. Cl. 712/220; 712/E09.016

(57) ABSTRACT

A data processing apparatus may include a processing unit that performs processing related to data, a first register that holds a value for defining an operation of the processing unit, a second register that holds a value output from the first register, the second register outputting the value to the processing unit, a first control unit that performs control for writing a value in the first register, a second control unit that performs control for rewriting the value held by the second register with the value output from the first register, after the value is written in the first register, and a third control unit that performs control for rewriting the value held by the second register with an invalid value, at which the processing of the processing unit is stopped, during a period for which the value is written in the first register.

### BACKGROUND OF THE INVENTION

1. Field of the Invention

The present invention relates to a data processing apparatus including a register with a two-stage configuration that holds a value for defining the operation of processing related to data including images and the like.

Priority is claimed on Japanese Patent Application No. 2010-257842, filed Nov. 18, 2010, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

In a generally known data processing apparatus such as an image processing apparatus, a central processing unit (CPU) sets a value in a register of each circuit, and each circuit changes a processing content according to the setting value of the register. FIG. 5 is a block diagram illustrating a configuration of a general image processing apparatus. The image processing apparatus illustrated in FIG. 5 includes a CPU 1, an imaging device 2, an imaging control unit 3, an image processing unit 4, a display control unit 5, a display device 6, serial communication units 7 and 8, a dynamic random access memory (DRAM) 9, a DRAM controller 10, a CPU bus B1, and a direct memory access (DMA) bus B2.

The CPU 1 communicates with each element of the image processing apparatus via the CPU bus B1 to control each element. The imaging device 2 is a charge coupled device (CCD), a complementary metal oxide semiconductor (CMOS) sensor or the like, and includes a sensor unit, a timing generation unit, a register group, and a serial interface unit. The sensor unit includes pixels arranged in a two dimensional manner, converts an object image incident from an exterior into an electrical signal, and outputs the electrical signal to the imaging control unit 3 of the next stage as image data. The timing generation unit generates a clock for driving the sensor unit, or synchronization signals (a horizontal synchronization signal and a vertical synchronization signal). The register group holds a value for defining the operation of each circuit in the imaging device 2. The serial interface unit communicates with the serial communication unit 7.

The imaging control unit 3 is a device for performing predetermined processing with respect to image data output from the imaging device 2, and includes a pre-processing unit, a timing generation unit, a DMA interface unit, a register group, and a CPU interface unit. The pre-processing unit performs processing with respect to the image data to remove a vertical streak occurring in an image, or remove shading caused by the aberration of a lens. The timing generation unit generates a clock for driving the pre-processing unit. The DMA interface unit transmits the image data processed by the pre-processing unit to the DRAM controller 10. The register group holds a value for defining the operation of each circuit in the imaging control unit 3. The CPU interface unit communicates with the CPU 1.

The image processing unit 4 is a device for performing predetermined image processing with respect to the image data processed by the imaging control unit 3, and includes an image process unit, a DMA interface unit, a register group, and a CPU interface unit. The image process unit performs image processing, such as a process for converting Bayer-format data into luminance and color difference data, a filtering process, a resizing process for changing a size according to the number of pixels of the display device 6, and the like, with respect to the image data processed by the imaging control unit 3. The DMA interface unit acquires the image data processed by the imaging control unit 3 from the DRAM controller 10, and outputs the image data to the image process unit. Furthermore, the DMA interface unit transmits the image data processed by the image process unit to the DRAM controller 10. The register group holds a value for defining the operation of each circuit in the image processing unit 4. The CPU interface unit communicates with the CPU 1.

The display control unit 5 is a device for performing processing for display with respect to the image data processed by the image processing unit 4, and includes a display processing unit, a timing generation unit, a DMA interface unit, a register group, and a CPU interface unit. The display processing unit performs processing with respect to the image data processed by the image processing unit 4, wherein the processing. includes processing for superimposing on-screen display (OSD) information on an image, color conversion processing unique for the display device 6, and the like. The timing generation unit generates synchronization signals (a horizontal synchronization signal and a vertical synchronization signal) for the display device 6. The DMA interface unit acquires the image data processed by the image processing unit 4 from the DRAM controller 10, and outputs the image data to the display processing unit. The register group. holds a value for defining the operation of each circuit in the display control unit 5. The CPU interface unit communicates with the CPU 1.

The display device 6 is a device such as a thin film transistor (TFT), and includes a display unit, a timing generation unit, a register group, and a serial interface unit. The display unit displays an image based on the data for display processed by the display control unit 5. The timing generation unit receives the synchronization signals generated by the display control unit 5, and outputs the synchronization signals to the display unit. The register group holds a value for defining the operation of each circuit in the display device 6. The serial interface unit communicates with the serial communication unit 8.

The serial communication unit 7 is a device for communicating with the CPU 1 and the imaging device 2 to set values in registers, and includes a register group, a CPU interface unit, and a serial interface unit. The register group holds a value for defining the operation of each circuit in the serial communication unit 7. The CPU interface unit communicates with the CPU 1. The serial interface unit communicates with the imaging device 2.

The serial communication unit 8 is a device for communicating with the CPU 1 and the display device 6 to set values in registers, and includes a register group, a CPU interface unit, and a serial interface unit. The register group holds a value for defining the operation of each circuit in the serial communication unit 8. The CPU interface unit communicates with the CPU 1. The serial interface unit communicates with the display device 6.

The DRAM 9 holds the image data processed by each element in the image processing apparatus. The DRAM controller 10 communicates with each element in the image processing apparatus via the DMA bus B2, and writes image data to the DRAM 9 or reads image data from the DRAM 9.

As described above, each element in the image processing apparatus includes the register group, and receives the setting value via the CPU interface unit or the serial interface unit and sets the setting value in the register group. It is possible for each element to change a processing content according to the setting value set in the register group. Hereinafter, a detailed configuration of the imaging control unit 3 will be described as an example.

FIG. 6 is a block diagram illustrating a configuration of the imaging control unit 3 provided in the image processing apparatus. The imaging control unit 3 illustrated in FIG. 6 includes a CPU interface unit 301, a register group 302, a timing generation unit 303, a pre-processing unit 304, and a DMA interface unit 305. The CPU interface unit 301 includes a reception buffer 306 and a write pulse generating unit 307. The register group 302 includes a first stage register group 308.

The reception buffer 306 temporarily holds a setting value received from the CPU 1 via the CPU bus B1. The write pulse generating unit 307 generates a write pulse for writing the setting value, which is held by the reception buffer 306, to the first stage register group 308 of the register group 302 based on an address signal and a write enable signal to be received from the CPU 1 via the CPU bus B1. The setting value is set in the first stage register group 308 based on the write pulse. The first stage register group 308 includes a plurality of registers for holding setting values for defining the operations of the timing generation unit 303, the pre-processing unit 304, and the DMA interface unit 305, and outputting the setting values to each circuit.

Hereinafter, timings at which setting values are set in the first stage register group 308 will be described. In the present specification, the case in which the imaging device 2 performs imaging in a frame period will be described. However, the following description will also be applied in the same manner to the case in which the imaging device 2 performs imaging with a field period (to a preferred embodiment of the present invention which will be described later).

FIG. 7 is a timing chart illustrating timings at which setting values are set in registers. As illustrated in FIG. 7, each frame is processed in synchronization with a vertical synchronization signal, and a setting value required for processing a next frame is set in the first stage register group 308 during the processing of each frame (for example, during a blanking period). The setting of the setting value to the first stage register group 308 needs to be done before the processing of the next frame starts. However, when the number of registers in which setting values are to be set is large, the setting may not be done during the processing of each frame. For example, when the setting of a setting value required for processing an (N+1)th frame is not done until the processing of the (N+1)th frame starts, a problem in which the (N+1)th frame is processed using a setting value used for processing an Nth frame may occur.

In order to prevent the above-mentioned problem from occurring, a method in which a register with a two-stage configuration is provided to ensure setting times of setting values to registers has been disclosed. FIG. 8 is a block diagram illustrating a configuration of the imaging control unit 3 including a register with a two-stage configuration. As illustrated in FIG. 8, a second stage register group 309 is added after the first stage register group 308. The second stage register group 309 includes a plurality of registers for holding setting values for defining the operations of a timing generation unit 303, a pre-processing unit 304, and a DMA interface unit 305. The timing generation unit 303, the pre-processing unit 304, and the DMA interface unit 305 perform processing with reference to the setting values of the second stage register group 309.

Furthermore, an update timing generation unit 310 is added to generate an update timing signal indicating an update timing of the setting value of the second stage register group 309. The setting values held by the first state register group 308 are simultaneously copied into the second stage register group 309 based on the update timing signal, and the setting values of the second stage register group 309 are updated. The update is performed in a short time as compared with the setting of the setting values to the first stage register group 308.

Hereinafter, the setting timings of setting values of the first stage register group 308 and the update timings of the setting values of the second stage register group 309 will be described. FIG. 9 is a timing chart illustrating the setting and update timings of setting values of registers. As illustrated in FIG. 9, each frame is processed in synchronization with a vertical synchronization signal, and setting values required for processing a next frame are set in the first stage register group 308 at timings such as the processing of frames. Then, at the update timings illustrated in FIG. 9, the setting values held by the first stage register group 308 are simultaneously held by the second stage register group 309.

Since each circuit refers to the setting values of the second stage register group 309 during the processing, even when each circuit is performing the processing, it is possible to set the setting values in the first stage register group 308. As described above, the register with the two-stage configuration is provided, so that it is possible to provide a margin to the setting time of the setting values of the first stage register group 308. With such a configuration, even when a processing period (for example, a blanking period) of each frame is extremely short, it is possible to set the setting values in the first stage register group 308.

The provision of the two-stage configuration as described above is disclosed, for example, in Japanese Unexamined Patent Application, First Publication No.

2009-088847. In detail, paragraph [0002] of Japanese Unexamined Patent Application, First Publication No. 2009-088847 expresses that “register setting is held until a communication period is completed and reflected in synchronization with an update timing according to a pulse signal.”

Hereinafter, the update timings of the setting values of the second stage register group 309 will be described. FIG. 10 is a timing chart illustrating the update timings of setting values of registers. As illustrated in FIG. 10, image data is input in units of lines of a pixel arrangement in synchronization with a vertical synchronization signal and a horizontal synchronization signal. FIG. 10 illustrates that data to be processed is valid data and data not to be processed is invalid data. As illustrated in FIG. 10, it is possible to update the setting values of the second stage register group 309 at timings (timings serving as the division of a frame) based on the vertical synchronization signal.

The update timing may not be the timing (the timing serving as the division of the frame) based on the vertical synchronization signal as described above, or may be an arbitrary timing. Hereinafter, another example of the update timing, is shown.

FIG. 11 is a timing chart illustrating the update timings of setting values of registers. FIG. 11 illustrates an example in which data is processed over a plurality of frames and valid data is continuously input across the division of a frame based on the vertical synchronization signal. Since it is probable that each circuit refers to the setting values of the second stage register group 309 during the input period of the valid data, the setting values of the second stage register group 309 are updated during the input period of the invalid data. In order to maximize the setting times of the setting values of the first stage register group 308, it is preferable that the update timings of the setting values of the second stage register group 309 be immediately before the valid data is input.

A data area where each circuit performs processing can be designated by register setting values. FIG. 12 is a timing chart illustrating the operation for performing processing in an area designated by register setting values. FIG. 12 illustrates an example in which areas to be processed are designated by the register setting values. In order to set valid data as an object to be processed, two types of setting values V_AREA_START and V_AREA_WIDTH are prepared. The setting value V_AREA_START indicates a processing start position in units of lines and the setting value V_AREA_WIDTH indicates an area to be processed in units of lines. In the example illustrated in FIG. 12, V_AREA_START is 4 and V_AREA_WIDTH is 8. That is, a fourth line is set as the processing start position and data corresponding to eight lines is processed.

As illustrated in FIG. 12, a vertical counter operates in synchronization with a vertical synchronization signal and a horizontal synchronization signal. The vertical counter is provided in the timing generation unit 303. The vertical counter is reset at a timing based on the vertical synchronization signal and a count-up operation is performed at a timing based on the horizontal synchronization signal. Since the. setting value V_AREA_START is 4, each circuit does not perform processing by determining that input data is invalid data in four lines in which the value of the vertical counter is 0 to 3. Furthermore, since the setting value V_AREA_WIDTH is 8, each circuit performs processing by determining that input data is valid data in eight lines after the value of the vertical counter becomes 4.

FIG. 13 is a timing chart illustrating the operation for performing processing in areas designated by register setting values. FIG. 13 illustrates an example in which areas to be processed are designated by the register setting values by means of a register with a two-stage configuration. In FIG. 13, among the setting values of the first stage register group 308, a setting value R1_V_AREA_START indicates a processing start position and a setting value R1_V_AREA_WIDTH indicates an area to be processed. Furthermore, among the setting values of the second stage register group 309, a setting value R2_V_AREA_START indicates a processing start position and a setting value R2_V_AREA_WIDTH indicates an area to be processed.

In the initial state of FIG. 13, the setting value R1_V_AREA_START of the first stage register group 308 is 4 and the setting value R1_V_AREA_WIDTH thereof is 8. These setting values are reflected in the second stage register group 309 at a timing immediately before valid data is input. Thus, in the initial frame of FIG. 13, each circuit processes data corresponding to eight lines after the value of the vertical counter becomes 4. If the setting values of the first stage register group 308 are reflected in the second stage register group 309, it is possible for the CPU 1 to set a next setting value in the first stage register group 308. In the example of FIG. 13, 2 is set as the setting value R1_V_AREA_START of the first stage register group 308 by the CPU 1, and 9 is set as the setting value R1_V_AREA_WIDTH.

The setting. values R1_V_AREA_START and R1_V_AREA_WIDTH of the first stage register group 308 are reflected in the second stave register group 309 at a timing immediately before valid data of a next frame is input. Thus, in this frame, each circuit processes data corresponding to nine lines after the value of the vertical counter becomes 2. If the setting values of the first stage register group 308 are reflected in the second stage register group 309, it is possible for the CPU 1 to set a next setting value in the first stage register group 308. In this way, areas to be processed can be designated by the register setting values by means of the register with the two-stage configuration.

However, when the register with the two-stage configuration is used, the following problem may occur. FIG. 14 is a timing chart illustrating the operation for performing processing in areas designated by register setting values. FIG. 14 illustrates an example when a problem occurs. In the example illustrated in FIG. 13, the setting value indicating the area to be processed is changed from a large value “4” to a small value “2.” However, in the example illustrated in FIG: 14, the setting value indicating the area to be processed is changed from a small value “2” to a large value “4.”

In the initial state of FIG. 14, the setting value R1_V_AREA_START of the first stage register group 308 is 2 and the setting value R1_V_AREA_WIDTH thereof is 9. These setting values are reflected in the second stage register group 309 at a timing immediately before valid data is input. If the setting values of the first stage register group 308 are reflected in the second stage register group 309, it is possible for the CPU 1 to set a next setting value in the first stage register group 308. In the example of FIG. 14, 4 is set as the setting value R1_V_AREA_START of the first stage register group 308 by the CPU 1, and 8 is set as the setting value R1_V_AREA_WIDTH.

Then, the setting values R1_V_AREA_START and R1_V_AREA_WIDTH of the first stage register group 308 are reflected in the second stage register group 309 at a timing immediately before valid data of a next frame is input. Thus, the setting value R2_V_AREA_START of the second stage register group 309 is updated from 2 to 4, and the setting value R2_V_AREA_WIDTH thereof is updated from 9 to 8. Therefore, since processing is started from data of a fourth line in this frame but the setting value R2_V_AREA_START before being updated is 2, processing may he started at a timing=at which data of a second line is input. As described above, in the image processing apparatus of the related art, since processing may be started at a timing different from a desired processing start timing in relation to the setting timings of the setting values of the first stage register group 308 and the update timings of the setting values of the second stage register group 309, desired processing may not be performed.

FIG. 15 is a timing chart illustrating the operation for performing processing in areas designated by register setting values. As illustrated in FIG. 15, it is sufficient if a timing for updating the setting value of the second stage register group 309 is advanced as compared with a timing at which the value of the vertical counter is 2. However, if the timing for updating the setting value of the second stage register group 309 is advanced, since the time required for setting a setting value in the first stage register group 308 is reduced, it is not preferable.

Recently, there has been increasing demand for multifunction and high performance in recent image processing apparatuses. In order to achieve the multifunction, it is generally necessary to set a plurality of registers. Furthermore, in order to achieve the high performance, it is necessary to secure a time required for performing register setting.

### SUMMARY

The present invention provides a data processing apparatus capable of achieving multifunction and high performance by securing a time required for performing register setting.

A data processing apparatus may include: a processing unit that performs processing related to data; a first register that holds a value for defining an operation of the processing unit; a second register that holds a value output from the first register, the second register outputting the value to the processing unit; a first control unit that performs control for writing a value in the first register; a second control unit that performs control for rewriting the value held by the second register with the value output from the first register, after the value is written in the first register; and a third control unit that performs control for rewriting the value held by the second register with an invalid value, at which the processing of the processing unit is stopped; during a period for which the value is written in the first register.

The data processing apparatus may further include a counter. When a value of the counter has reached a predetermined value, the third control unit may perform the control for rewriting the value held by the second register with the invalid value. When the processing of the processing unit is completed, the third control unit may perform the control for rewriting the value held by the second register with the invalid value.

When a CPU has generated a predetermined command, the third control unit may perform the control for rewriting the value held by the second register with the invalid value.

In addition to the control for rewriting the value held by the second register with the invalid value, the third control unit may perform control for rewriting the value held by the second register with a standard value to allow the processing unit to perform a predetermined function.

In addition to the control for rewriting the value held by the second register with the invalid value, the third control unit may perform control for rewriting the value held by the second register with an initial value set immediately after the data processing apparatus is powered on.

According the present invention, a value held by the second register is rewritten with an invalid value, so that processing of the processing unit can be stopped. Consequently, since a value is written in the first register, the value held by the second register is rewritten with the invalid value during a period for which the value held by the second register may not be rewritten with the value of the first register, so that the processing unit can be prevented from starting the processing using the value of the second register. Thereby, it is possible to achieve multifunction and high performance by ensuring a time required for register setting.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram illustrating a configuration of an imaging control unit provided in an image processing apparatus in accordance with a first preferred embodiment of the present invention;

FIG. 2 is a timing chart illustrating setting and update clear timings of setting values of registers in accordance with the first preferred embodiment of the present invention;

FIG. 3 is a timing chart illustrating setting and update clear timings of setting values of registers in accordance with the first preferred embodiment of the present invention;

FIG. 4 is a block diagram illustrating a configuration (a modification example) of an imaging control unit provided in the image processing apparatus in accordance with the first preferred embodiment of the present invention;

FIG. 5 is a block diagram illustrating a configuration of a general image processing apparatus;

FIG. 6 is a block diagram illustrating a configuration of the imaging control unit provided in the image processing apparatus;

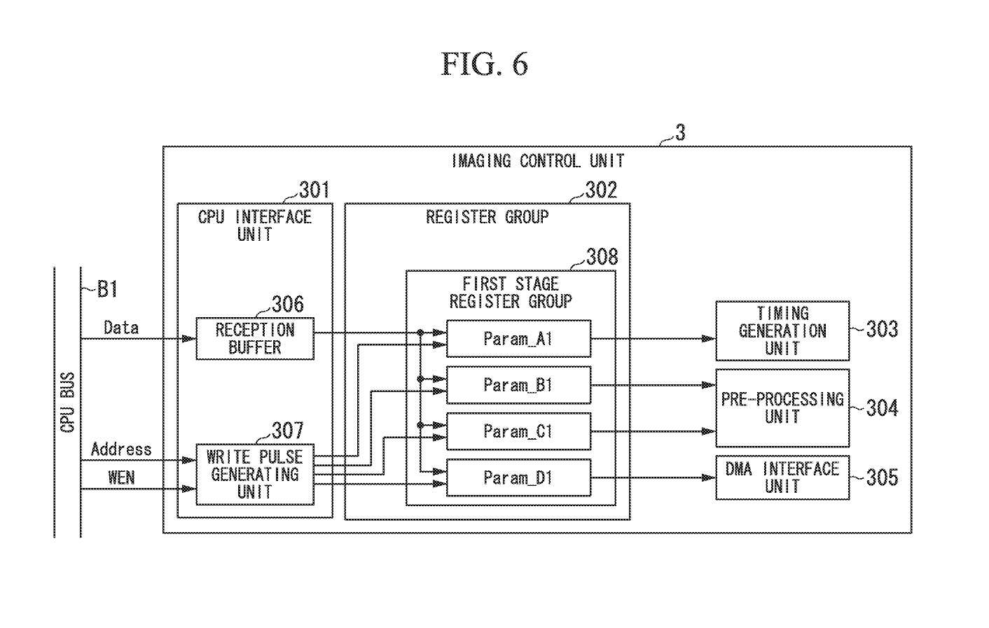

FIG. 7 is a timing chart illustrating timings at which setting values are set in registers;

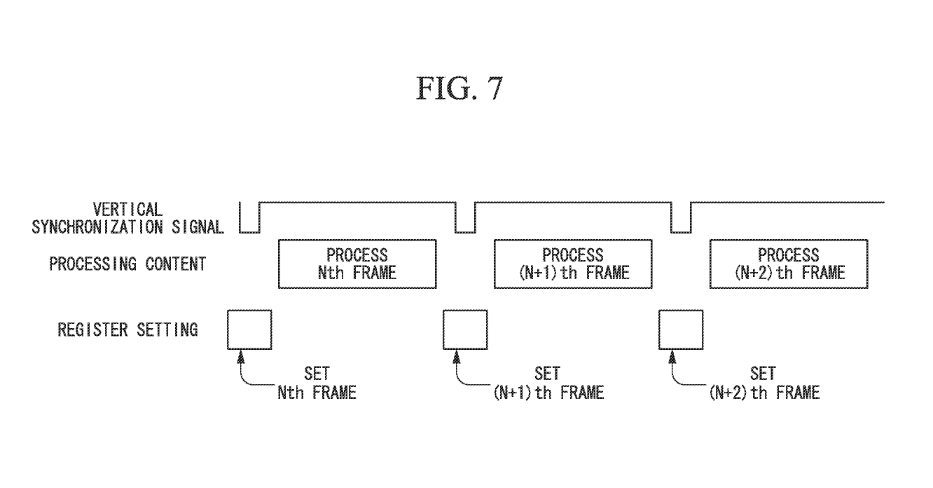

FIG. 8 is a block diagram illustrating a configuration of the imaging control unit including a register with a two-stage configuration;

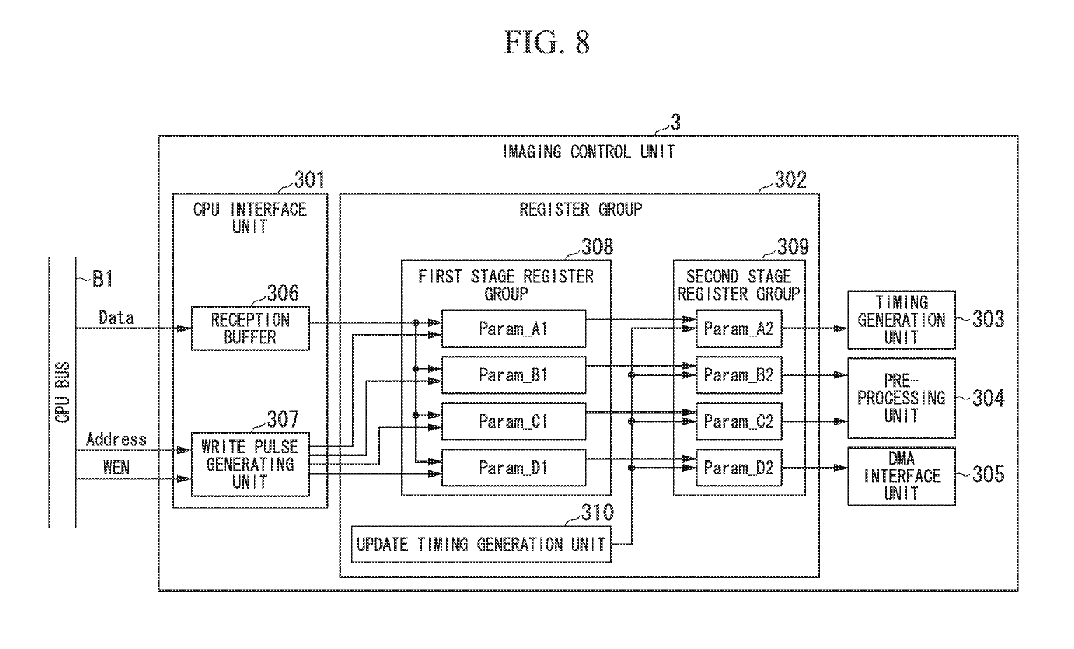

FIG. 9 is a timing chart illustrating the setting and update timings of setting values of registers;

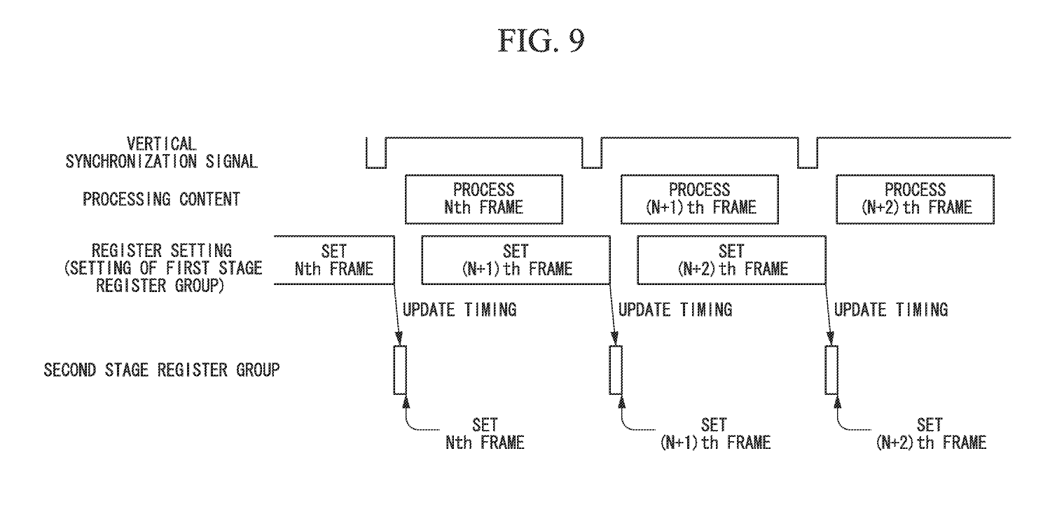

FIG. 10 is a timing chart illustrating the update timings of setting values of registers;

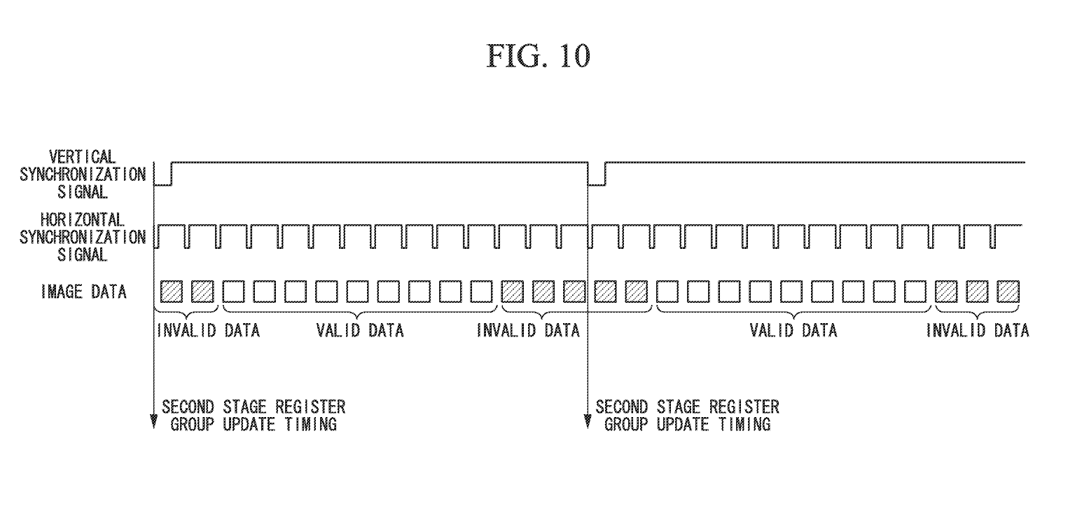

FIG. 11 is a timing chart illustrating the update timings of setting values of registers;

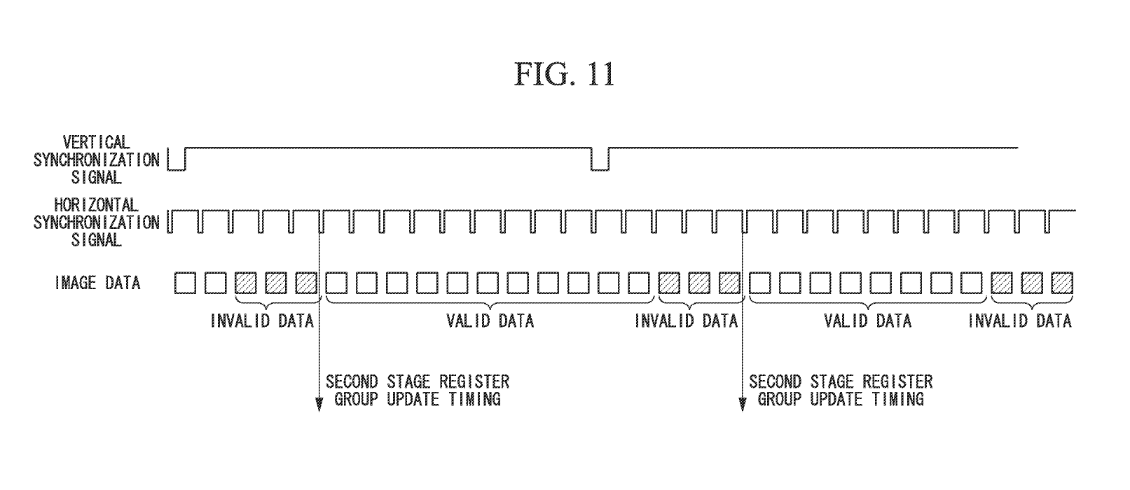

FIG. 12 is a timing chart illustrating the operation for performing processing in an area designated by register setting values;

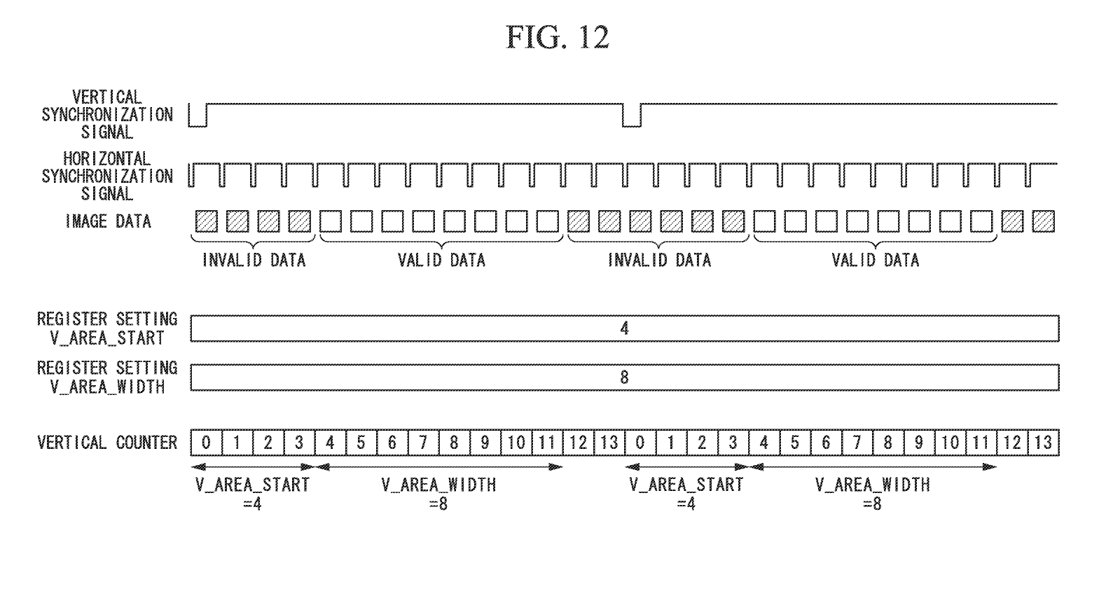

FIG. 13 is a timing chart illustrating the operation for performing processing in areas designated by register setting values;

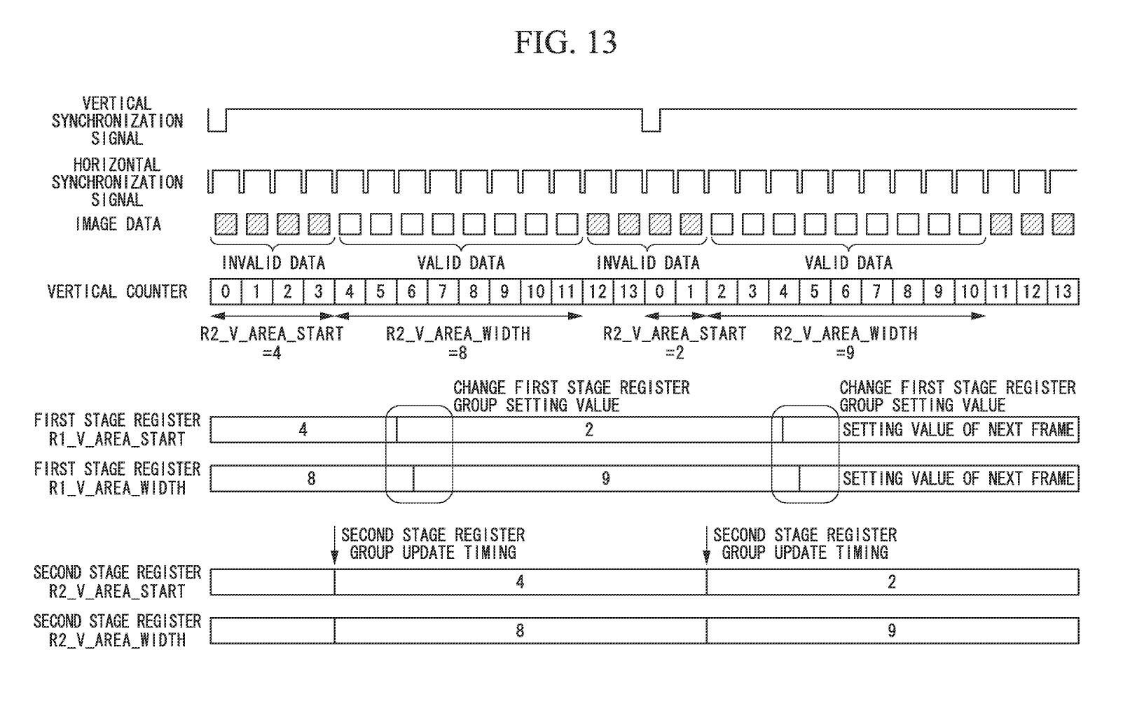

FIG. 14 is a timing chart illustrating the operation for performing processing in areas designated by register setting values; and

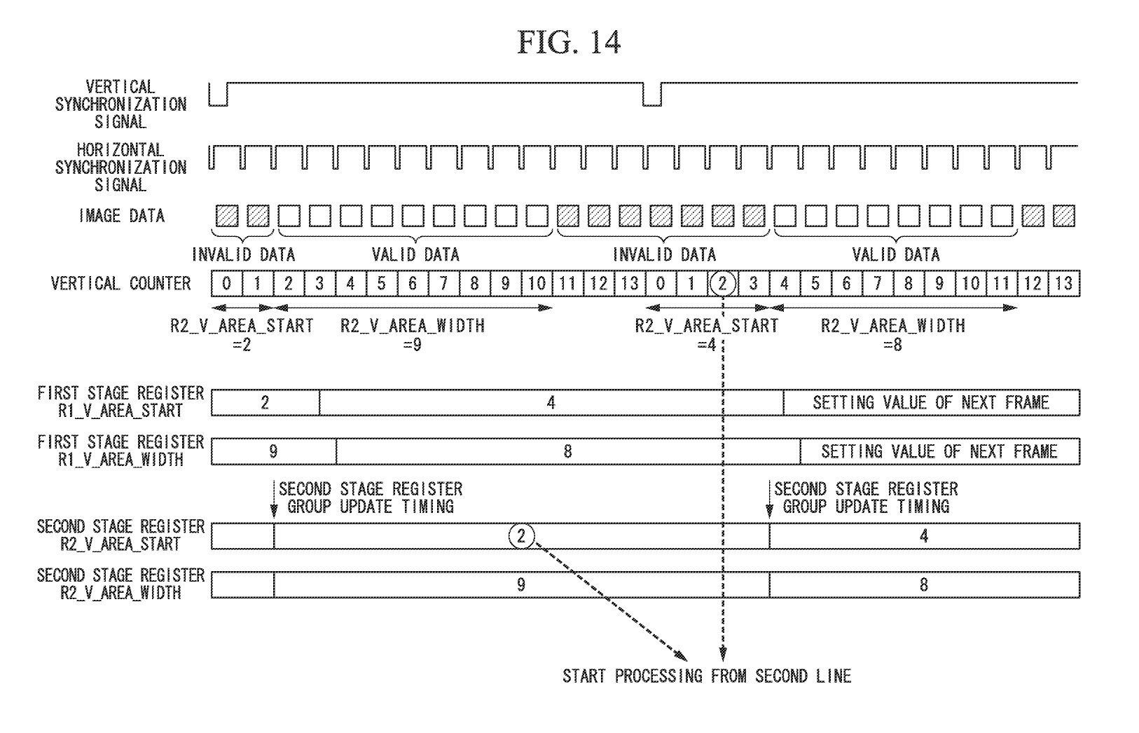

FIG. 15 is a timing chart illustrating the operation for performing processing in areas designated by register setting values.

### DETAILED DESCRIPTION OF THE PREFERRED EMBODIMENTS

The present invention will he now described herein with reference to illustrative preferred embodiments. Those skilled in the art will recognize that many alternative preferred embodiments can be accomplished using the teaching of the present invention and that the present invention is not limited to the preferred embodiments illustrated for explanatory purpose.

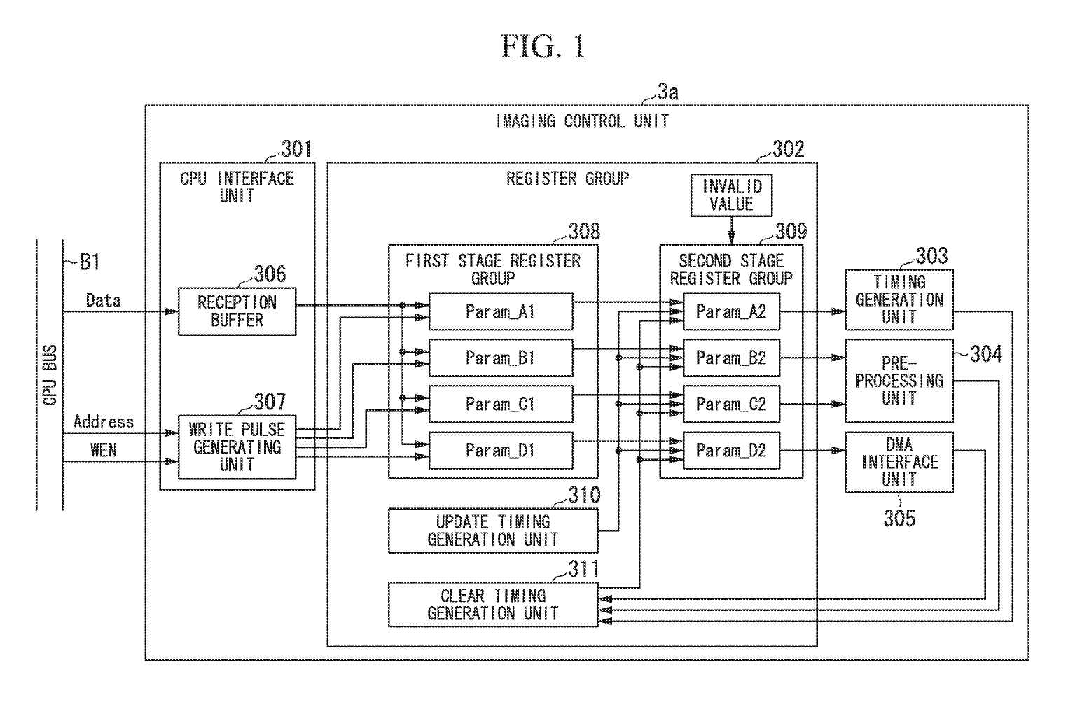

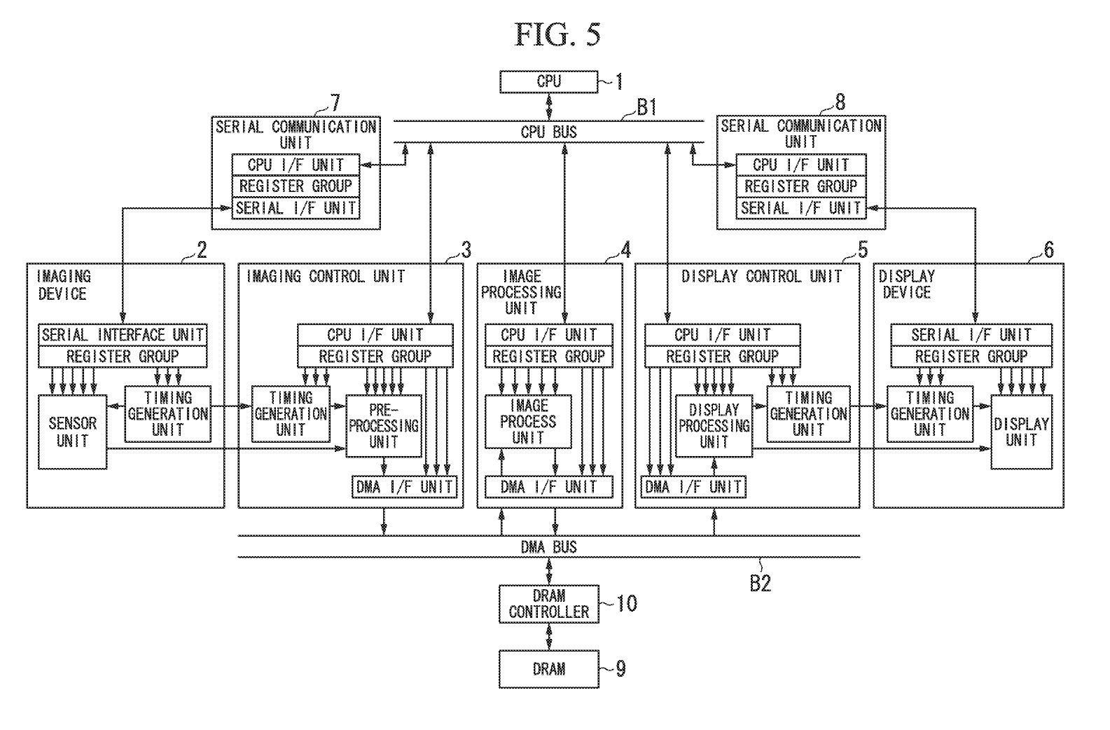

The entire configuration of an image processing apparatus (a data processing apparatus) according to the present preferred embodiment is substantially the same as the configuration illustrated in FIG. 5. However, in the present preferred embodiment, the imaging control unit 3 is changed to an imaging control unit 3a illustrated in FIG. 1.

FIG. 1 is a block diagram illustrating a configuration of an imaging control unit provided in an image processing apparatus in accordance with a first preferred embodiment of the present invention. When the imaging control unit 3a illustrated in FIG. 1 is compared with the imaging control unit 3 illustrated in FIG. 5, a clear timing generation unit 311 is additionally provided. The clear timing generation unit 311 generates a clear timing signal indicating a timing at which a setting value held by a second stage register group 309 is rewritten (cleared) with a predetermined value. The predetermined value of the present preferred embodiment includes a value at which each circuit does not react, that is, processing of each circuit is stopped. This value is set as an invalid value.

The invalid value, for example, is 0×FFFF or 0×0. A special meaning may be given to such a value and a circuit may not be allowed to react to the value, or a vertical counter in a timing generation unit 303 may not be allowed to have such a value. The invalid value is supplied to the second stage register group 309 through a path different from a setting value set from a CPU 1. Input of the second stage register group 309 may be switched between a setting value output from a first stage register group 308 and the invalid value.

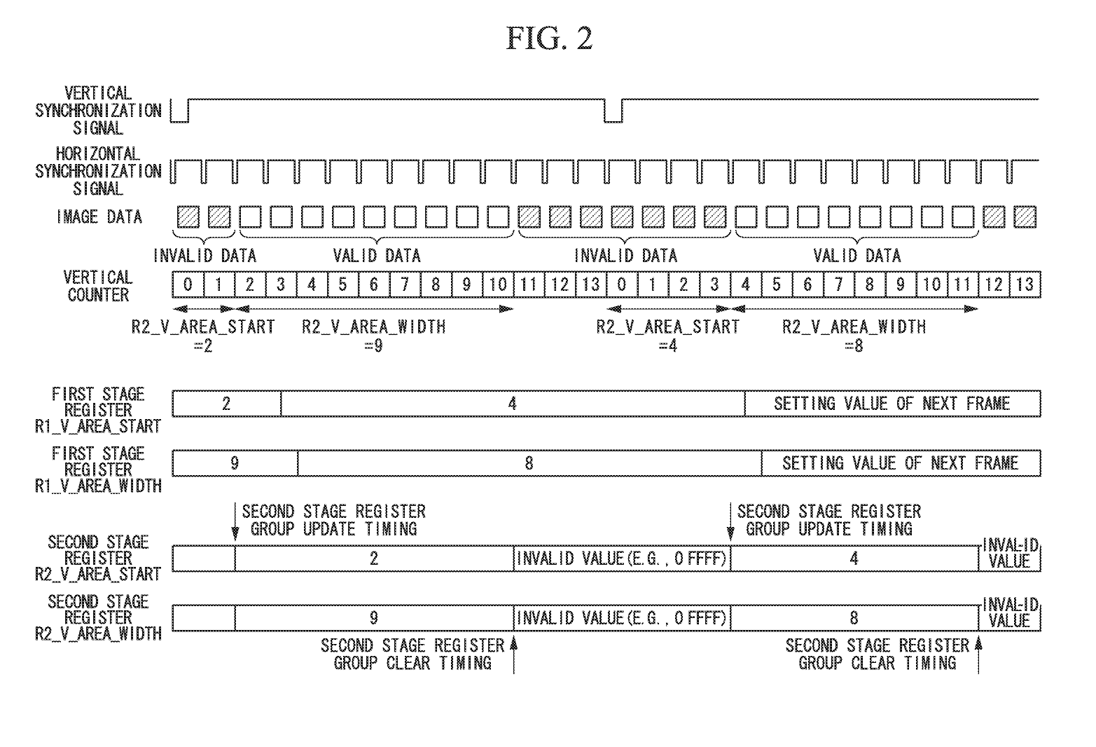

FIG. 2 is a timing chart illustrating setting and update clear timings of setting values of registers in accordance with the first preferred embodiment of the present invention. With reference to FIG. 2, the setting timings of setting values to the first stage register group 308 and the update clear timings of setting values to the second stage register group 309 will be described. A setting value R1_V_AREA_START held by the first stage register group 308 indicates a processing start position and a setting value R1_V_AREA_WIDTH indicates an area to be processed. Similarly, a setting value R2_V_AREA_START held by the second stage register group 309 indicates a processing start position and a setting value R2_V_AREA_WIDTH indicates an area to be processed.

As illustrated in FIG. 2, the vertical counter in the timing generation unit 303 operates in synchronization with a vertical synchronization signal and a horizontal synchronization signal. The vertical counter is reset at a timing based on the vertical synchronization signal and a count-up operation is performed at a timing based on the horizontal synchronization signal.

In the initial state of FIG. 2, the setting value R1_V_AREA_START of the first stage register group 308 is 2 and the setting value R1_V_AREA_WIDTH thereof is 9. An update timing generation unit 310 generates an update timing signal at a timing immediately before valid data is input, and outputs the update timing signal to the second stage register group 309. Based on the update timing signal, the setting values of the first stage register group 308 are reflected in the second stage register group 309. That is, the setting values held by the second stage register group 309 are rewritten with the setting, values output from the first stage register group 308. Thus, the setting value R2_V_AREA_START of the second stage register group 309 becomes 2 and the setting. value R2_V_AREA_WIDTH thereof becomes 9. Therefore, in this frame, each circuit processes data corresponding to nine lines after the value of the vertical counter becomes 2. If the setting values of the first stage register group 308 are reflected in the second stage register group 309, it is possible for the CPU 1 to set a setting value of a next frame in the first stage register group 308.

Setting values received from the CPU 1 via a CPU bus B1 are stored in a reception buffer 306. A write pulse generating unit 307 generates a write pulse based on an address signal received from the CPU 1 via the CPU bus B1, and outputs the write pulse to the first stage register group 308. Based on the write pulse, the setting values are set in the first stage register group 308. That is, the setting values from the CPU 1 are written in the first stage register group 308. In the example of FIG. 2, 4 is set as the setting value R1_V_AREA_START of the first stage register group 308 by the CPU 1, and 8 is set as the setting value R1_V_AREA_WIDTH thereof.

After the processing of valid data of an initial frame is completed, the clear timing generation unit 311 generates a clear timing signal and outputs the clear timing signal to the second stage register group 309. Based on the clear timing signal, the setting values of the second stage register group 309 are cleared with invalid values. That is, the setting values held by the second stage register group 309 are rewritten with invalid values. At this time, the setting values of the first stage register group 308 are not changed. Since the setting values held by the second stage register group 309 are the invalid values, each circuit does not perform processing even if each circuit refers to the invalid values.

The update timing generation unit 310 generates an update timing signal at a timing immediately before valid data of a next frame is input, and outputs the update timing signal to the second stage register group 309. Based on the update timing signal, the setting values of the first stage register group 308 are reflected in the second stage register group 309. That is, the setting values held by the second stage register group 309 are rewritten with the setting values output from the first stage register group 308. Thus, the setting value R2_V_AREA_START of the second stage register group 309 becomes 4 and the setting value R2_V_AREA_WIDTH thereof becomes 8. Therefore, in this frame, each circuit processes data corresponding to eight lines after the value of the vertical counter becomes 4. Then, the same operation is continuously performed.

As described above, since the setting values of the second stage register group 309 are cleared to be the invalid values and the invalid values are held up to a next update timing, the operation of each circuit can be stably stopped and restarted after the update timing.

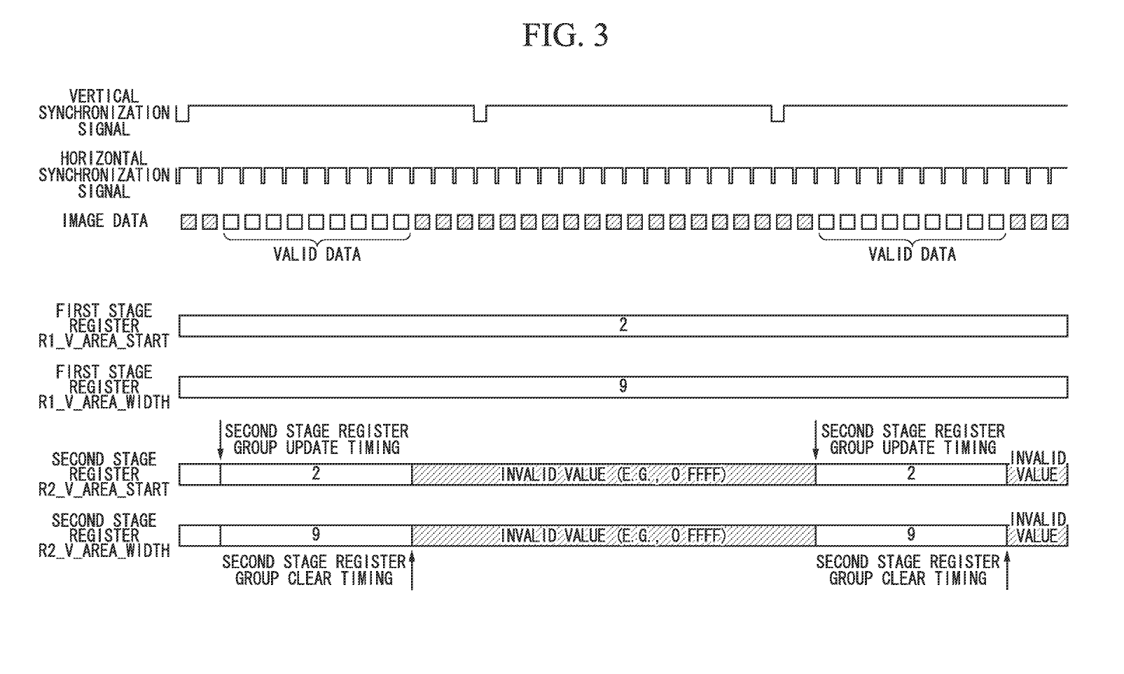

FIG. 3 is a timing chart illustrating setting and update clear timings of setting values of registers in accordance with the first preferred embodiment of the present invention. With reference to FIG. 3, another operation example will be described. In FIG. 3, setting values held by the first stage register group 308 are not changed and only setting values held by the second stage register group 309 are changed. In the example of FIG. 3, valid data of an initial frame is processed, and then no processing is required at a second frame. The setting values of the first stage register group 308 are reflected in the second stage register group 309 at a timing immediately before the valid data of the initial frame is input, and then the setting values of the second stage register group 309 are cleared with invalid values at a timing at which the processing of the valid data is completed. Thus, at the second frame, each circuit stops its own processing.

In addition, the setting values of the first state register group 308 are reflected in the second stage register group 309 at a timing immediately before valid data of a third frame is input. Thus, at the third frame, each circuit restarts its own processing.

Through the operation as described above, it is possible to stop the processing of only a predetermined frame. When there is no function of clearing the setting values of the second stage register group 309 with the invalid values based on the clear timing signal, since it is necessary to set the setting values of the first stage register group 308 as the invalid values by the CPU 1, and reflect the invalid values in the second stage register group 309 based on the update timing signal, the CPU 1 is loaded. On the other hand, the setting values of the second stage register group 309 are cleared with the invalid values based on the clear timing signal at a frame where processing is to be stopped as described above, so that the processing can be stopped and restarted without performing the setting of setting values with respect to the first stage register group 308, thereby reducing the load of the CPU 1.

The operation illustrated in FIG. 3 is applied when an imaging device 2 performs exposure with respect to a plurality of frames. When the exposure is performed with respect to the plurality of frames, image data is output from the imaging device 2 to the imaging control unit 3a at a frequency of 1 per the plurality of frames. For example, when the exposure is continuously performed during two frames, each circuit of the imaging control unit 3a performs its own processing at a frequency of 1 per two frames.

Next, a generation timing of the clear timing signal will be described. In the above-mentioned example, the clear timing generation unit 311 generates the clear timing signal when the value of the vertical counter has reached a predetermined value. The predetermined value corresponds to a position where the processing of the valid data is completed. In the example of FIG. 2, at the initial frame, the clear timing signal is generated when the value of the vertical counter has reached 11, and at the next frame, the clear timing signal is generated when the value of the vertical counter has reached 12. The value of the vertical counter indicating the generation timing of the clear timing signal may he held by the first stage register group 308 and the second stage register group 309 as a setting value, and the clear timing generation unit 311 may also generate the clear timing signal with reference to the setting value. As described above, the generation timing of the clear timing signal is set as a timing at which the value of the vertical counter reaches the predetermined value, so that the clear timing signal can be generated without applying load to the CPU 1.

The generation timing of the clear timing signal may include a timing at which predetermined processing is completed. For example, the clear timing generation unit 311 may also generate the clear timing signal when the processing of the valid data is completed. For example, when a pre-processing unit 304 has completed the processing of image data or a DMA interface unit 305 has completed the transmission of image data to a DRAM 9, the pre-processing unit 304 or the DMA interface unit 305 outputs a signal indicating the completion of the processing. The clear timing generation unit 311 outputs the clear timing signal based on this signal.

As described above, the generation timing of the clear timing signal is set as the timing at which the predetermined processing is completed, so that the clear timing signal can be generated without applying load to the CPU 1. For example, when a change has occurred in a processing time required for transmitting image data due to the overloaded state of a DMA bus B2, it is difficult to accurately recognize a processing completion timing from the value of the vertical counter. However, if the clear timing signal is generated at a timing at which the transmission of the image data is completed, the clear timing signal can be generated with more accuracy.

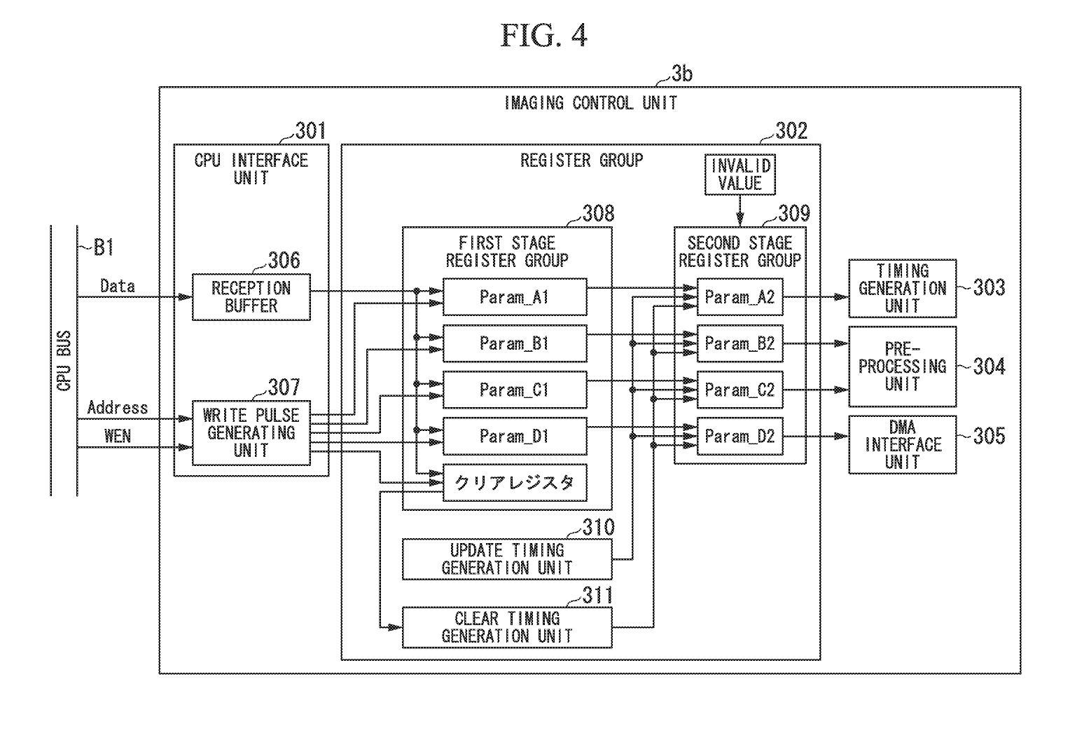

The generation timing of the clear timing signal may also be set as a timing at which the CPU 1 has generated a predetermined command. FIG. 4 is a block diagram illustrating a configuration (a modification example) of an imaging control unit provided in the image processing apparatus in accordance with the first preferred embodiment of the present invention. FIG. 4 illustrates a configuration in which the clear timing signal is generated at a timing at which the CPU 1 has generated a predetermined command. An imaging control unit 3b illustrated in FIG. 4 is substantially the same as the imaging control unit 3a illustrated in FIG. 1, except that a clear register for clearing is additionally provided to the first stage register group 308.

For example, the pre-processing unit 304 or the DMA interface unit 305 generates an interrupt at a timing at which the processing of valid data is completed, and the CPU 1 generates a clear command according to the interrupt. By the generation of the clear command, a setting value is set in the clear register of the first stage register group 308. The clear timing generation unit 311 detects that the setting value has been set in the clear register and generates the clear timing signal. Even when the CPU 1 generates a clear command at an arbitrary timing (for example, when processing is forcibly stopped midway, and the like), the clear timing signal can be generated in the same manner as above. As described above, if the generation timing of the clear timing signal is set as the timing at which the CPU 1 has generated the predetermined command, the clear timing signal can be generated at an arbitrary timing.

Next, another example of the predetermined value reflected in the second stage register group 309 based on the clear timing signal will be described. In the above-mentioned example, the predetermined value is an invalid value. However, the predetermined value may be a standard value which is a setting value recommended in order for each circuit to perform a predetermined function. For example, the setting value of the second stage register group 309 may be normally cleared with a standard value to allow each circlet to perform an operation at the time of standard setting, and when each circuit is allowed to perform an operation other than the operation at the time of the standard setting, the setting value of the first stage register group 308 may he rewritten and then the setting value of the second stage register group 309 may be updated with the setting value of the first stage register group 308. As described above, the setting value of the second stage register group 309 is cleared with the standard value, thereby reducing the load of the CPU 1 when the operation at the time of the standard setting is performed.

The predetermined value reflected in the second stage register group 309 based on the clear timing signal may also include an initial value set when the image processing apparatus is powered on and immediately starts to operate (at the time of power-on reset). Consequently, the state of the second stage register group 309 can be returned to the initial state without rewriting the setting value of the first stage register group 308.

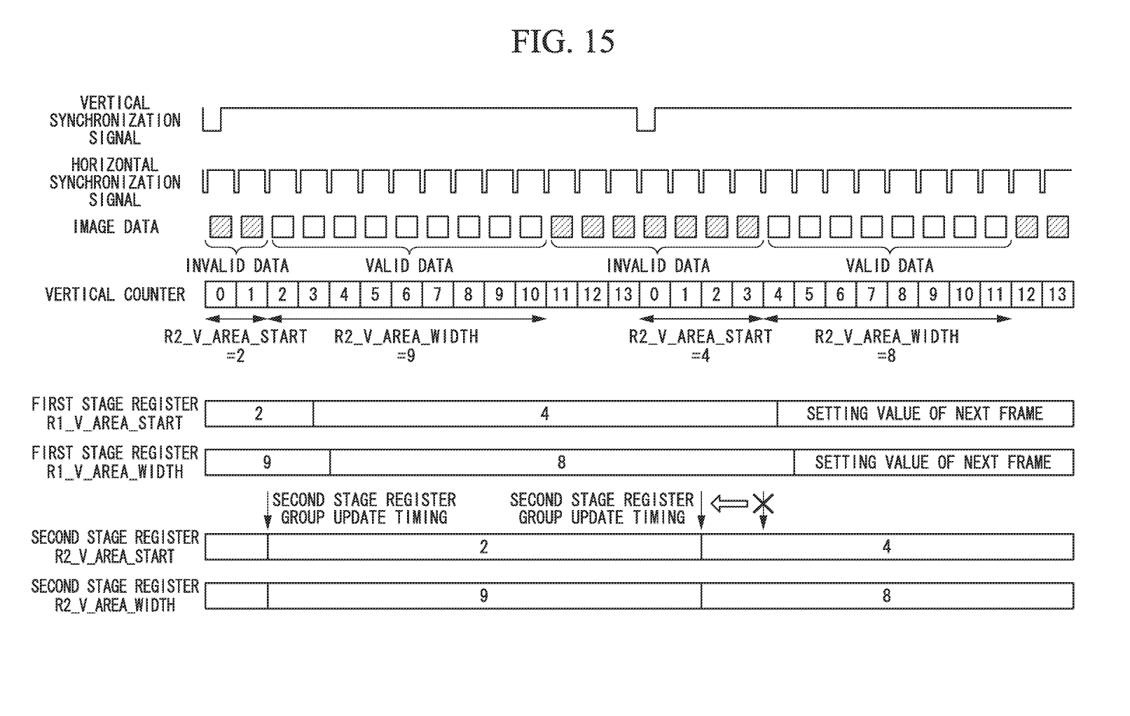

As described above, according. to the present preferred embodiment, the setting value of the second stage register group 309 is cleared with the invalid value, so that the processing of the processing units can be stopped. Thus, since a setting value is written in the first stage register group 308, the setting value of the second stage register group 309 is cleared with the invalid value during the period for which the setting value of the second stage register group 309 may not be rewritten with the setting value of the first stage register group 308, so that each circuit can be prevented from starting its own processing using the setting value of the second stage register group 309. Consequently, the update timing of the setting value of the second stage register group 309 does not need to be advanced as illustrated in FIG. 15, and a time required for register setting, can be ensured to achieve multifunction and high performance.

Furthermore, if the setting value of the second stage register group 309 is rewritten with the invalid value at a timing at which the value of the vertical counter has reached a predetermined value, it is possible to perform the rewriting of the setting value of the second stage register group 309 without applying load to the CPU 1. Moreover, if the setting value of the second stage register group 309 is rewritten with the invalid value at a timing at which predetermined processing is completed, it is possible to perform the rewriting of the setting value of the second stage register group 309 at a more accurate timing, as compared with a method of rewriting the setting value of the second stage register group 309 with the invalid value at the timing at which the value of the vertical counter has reached the predetermined value. Moreover, if the setting value of the second stage register group 309 is rewritten with the invalid value at a timing at which the CPU 1 has generated a predetermined command, it is possible to perform the rewriting of the setting value of the second stage register group 309 at an arbitrary timing.

Furthermore, if the setting value of the second stage register group 309 is rewritten with a standard value, it is possible to reduce load of the CPU 1 when an operation at the time of standard setting is performed. Moreover, if the setting value of the second stage register group 309 is rewritten with an initial value, it is possible to return the state of the second stage register group 309 to an initial state without rewriting the setting value of the first stage register group 308.

While preferred embodiments of the present invention have been described and illustrated above, it should be understood that these are examples of the present invention and are not to be considered as limiting. Additions, omissions, substitutions, and other modifications can be made without departing from the scope of the present invention. Examples in which the present invention is applied to the imaging control units 3a and 3b have been described. However, in the configuration illustrated in FIG. 5, the present invention can be applied in the same manner to the configuration having the register group. Furthermore, after a plurality of types of clear timing signals are configured to he generated, the second stage register group 309 may he cleared with a different setting value according to each clear timing signal. Accordingly, the invention is not to be considered as being limited by the foregoing description, and is only limited by the scope of the claims.

What is claimed is:

1. A data processing apparatus comprising:
a processing unit that performs processing related to data;
a first register that holds a value for defining an operation of the processing unit;
a second register that holds a value output from the first register, the second register outputting the value to the processing unit;
a first control unit that performs control for writing a value in the first register;
a second control unit that performs control for rewriting the value held by the second register with the value output from the first register, after the value is written in the first register; and
a third control unit that performs control for rewriting the value held by the second register with an invalid value, at which the processing of the processing unit is stopped, during a period for which the value is written in the first register.

2. The data processing apparatus according to claim 1, further comprising a counter, wherein, when a value of the counter has reached a predetermined value, the third control unit performs the control for rewriting the value held by the second register with the invalid value.

3. The data processing apparatus according to claim 1, wherein, when the processing of the processing unit is completed, the third control unit performs the control for rewriting the value held by the second register with the invalid value.

4. The data processing apparatus according to claim 1, wherein, when a CPU has generated a predetermined command, the third control unit performs the control for rewriting the value held by the second register with the invalid value.

5. The data processing apparatus according to claim 1, wherein, in addition to the control for rewriting the value held by the second register with the invalid value, the third control unit performs control for rewriting the value held by the second register with a standard value to allow the processing unit to perform a predetermined function.

6. The data processing apparatus according to claim 1, wherein, in addition to the control for rewriting the value held by the second register with the invalid value, the third control unit performs control for rewriting the value held by the second register with an initial value set immediately after the data processing apparatus is powered on.
